(19) United States
(12) Patent Application Publication
(10) Pub. No.: US 2022/0043664 A1
(43) Pub. Date: Feb. 10, 2022

(54) SYSTEMS AND METHODS FOR ACCELERATOR TASK PROFILING VIA VIRTUAL ACCELERATOR MANAGER BASED ON SLOT SPEED

(71) Applicant: Dell Products L.P., Round Rock, TX (US)

(72) Inventors: Ankit SINGH, Bangalore (IN); Deepaganesh PAULRAJ, Bangalore (IN); Vinod Parackal SABY, Bangalore (IN)

(73) Assignee: Dell Products L.P., Round Rock, TX (US)

(21) Appl. No.: 16/989,002

(22) Filed: Aug. 10, 2020

(51) Int. Cl. G06F 9/455

(52) U.S. Cl. CPC G06F 9/45533

(57) ABSTRACT

An information handling system may include a plurality of hardware accelerator devices and a processor subsystem having access to a memory subsystem and having access to the plurality of hardware accelerator devices, wherein the memory subsystem stores instructions executable by the processor subsystem, the instructions, when executed by the processor subsystem, causing the processor subsystem to: responsive to issuance of, by an application executing on a virtual machine of a hypervisor executing on the processor subsystem, an instruction triggering an event for use of a selected hardware accelerator device of the plurality of hardware accelerator devices, invoke a virtual acceleration manager of the hypervisor to handle the instruction; determine by the virtual acceleration manager an amount of data to be transferred between the processor subsystem and the selected hardware accelerator device; select by the virtual acceleration manager the selected hardware accelerator based on the amount of data to be transferred; and distribute by the virtual acceleration manager the instruction to the selected hardware accelerator device.

### TECHNICAL FIELD

This disclosure relates generally to virtualized information handling systems and more particularly to systems and methods for accelerator task profiling via virtual accelerator manager based on slot speed in an information handling system environment.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Increasingly, information handling systems are deployed in architectures that allow multiple operating systems to run on a single information handling system. Labeled “virtualization,” this type of information handling system architecture decouples software from hardware and presents a logical view of physical hardware to software. In a virtualized information handling system, a single physical server may instantiate multiple, independent virtual servers. Server virtualization is enabled primarily by a piece of software (often referred to as a “hypervisor”) that provides a software layer between the server hardware and the multiple operating systems, also referred to as guest operating systems (guest OS). The hypervisor software provides a container that presents a logical hardware interface to the guest operating systems. An individual guest OS, along with various applications or other software executing under the guest OS, may be unaware that execution is occurring in a virtualized server environment (as opposed to a dedicated physical server). Such an instance of a guest OS executing under a hypervisor may be referred to as a “virtual machine” or “VM”.

Often, virtualized architectures may be employed for numerous reasons, such as, but not limited to: (1) increased hardware resource utilization; (2) cost-effective scalability across a common, standards-based infrastructure; (3) workload portability across multiple servers; (4) streamlining of application development by certifying to a common virtual interface rather than multiple implementations of physical hardware; and (5) encapsulation of complex configurations into a file that is easily replicated and provisioned, among other reasons. As noted above, the information handling system may include one or more operating systems, for example, executing as guest operating systems in respective virtual machines.

An operating system serves many functions, such as controlling access to hardware resources and controlling the execution of application software. Operating systems also provide resources and services to support application software. These resources and services may include data storage, support for at least one file system, a centralized configuration database (such as the registry found in Microsoft Windows operating systems), a directory service, a graphical user interface, a networking stack, device drivers, and device management software. In some instances, services may be provided by other application software running on the information handling system, such as a database server.

The information handling system may include multiple processors connected to various devices, such as Peripheral Component Interconnect (“PCI”) devices and PCI express (“PCIe”) devices. The operating system may include one or more drivers configured to facilitate the use of the devices. As mentioned previously, the information handling system may also run one or more virtual machines, each of which may instantiate a guest operating system. Virtual machines may be managed by a virtual machine manager, such as, for example, a hypervisor. Certain virtual machines may be configured for device pass-through, such that the virtual machine may utilize a physical device directly without requiring the intermediate use of operating system drivers.

A virtual machine infrastructure may include multiple hardware accelerators deployed in a single information handling system server to scale application performance and maximize production workflows. For example, a virtual machine infrastructure may include multiple graphics processing units (GPUs) as hardware accelerators for acceleration of graphics.

Hardware accelerators are often coupled to processors via Peripheral Component Interconnect Express (PCIe) slots. In architectures including hardware accelerators coupled to PCIe slots with differing bandwidths, critical tasks assigned to accelerators coupled to a lower bandwidth slot may negatively affect overall system performance and lead to bottlenecks.

### SUMMARY

In accordance with the teachings of the present disclosure, the disadvantages and problems associated with existing approaches to assigning tasks to hardware accelerators may be reduced or eliminated.

In accordance with embodiments of the present disclosure, an information handling system may include a plurality of hardware accelerator devices and a processor subsystem having access to a memory subsystem and having access to the plurality of hardware accelerator devices, wherein the memory subsystem stores instructions executable by the processor subsystem, the instructions, when executed by the processor subsystem, causing the processor subsystem to: responsive to issuance of, by an application executing on a virtual machine of a hypervisor executing on the processor subsystem, an instruction triggering an event for use of a selected hardware accelerator device of the plurality of hardware accelerator devices, invoke a virtual acceleration manager of the hypervisor to handle the instruction; determine by the virtual acceleration manager an amount of data to be transferred between the processor subsystem and the selected hardware accelerator device; select by the virtual acceleration manager the selected hardware accelerator based on the amount of data to be transferred; and distribute by the virtual acceleration manager the instruction to the selected hardware accelerator device.

In accordance with these and other embodiments of the present disclosure, a method may include responsive to issuance of, by an application executing on a virtual machine of a hypervisor executing on a processor subsystem, an instruction triggering an event for use of a selected hardware accelerator device of a plurality of hardware accelerator devices, invoking a virtual acceleration manager of the hypervisor to handle the instruction. The method may also include determining by the virtual acceleration manager an amount of data to be transferred between the processor subsystem and the selected hardware accelerator device. The method may further include selecting by the virtual acceleration manager the selected hardware accelerator based on the amount of data to be transferred and distributing by the virtual acceleration manager the instruction to the selected hardware accelerator device.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to: responsive to issuance of, by an application executing on a virtual machine of a hypervisor executing on a processor subsystem, an instruction triggering an event for use of a selected hardware accelerator device of a plurality of hardware accelerator devices, invoke a virtual acceleration manager of the hypervisor to handle the instruction; determine by the virtual acceleration manager an amount of data to be transferred between the processor subsystem and the selected hardware accelerator device; select by the virtual acceleration manager the selected hardware accelerator based on the amount of data to be transferred; and distribute by the virtual acceleration manager the instruction to the selected hardware accelerator device.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected elements of an example information handling system using an accelerator device, in accordance with embodiments of the present disclosure; and

FIG. 2 illustrates a block diagram of selected elements of an example information handling system using a plurality of accelerator devices, in accordance with embodiments of the present disclosure.

### DETAILED DESCRIPTION

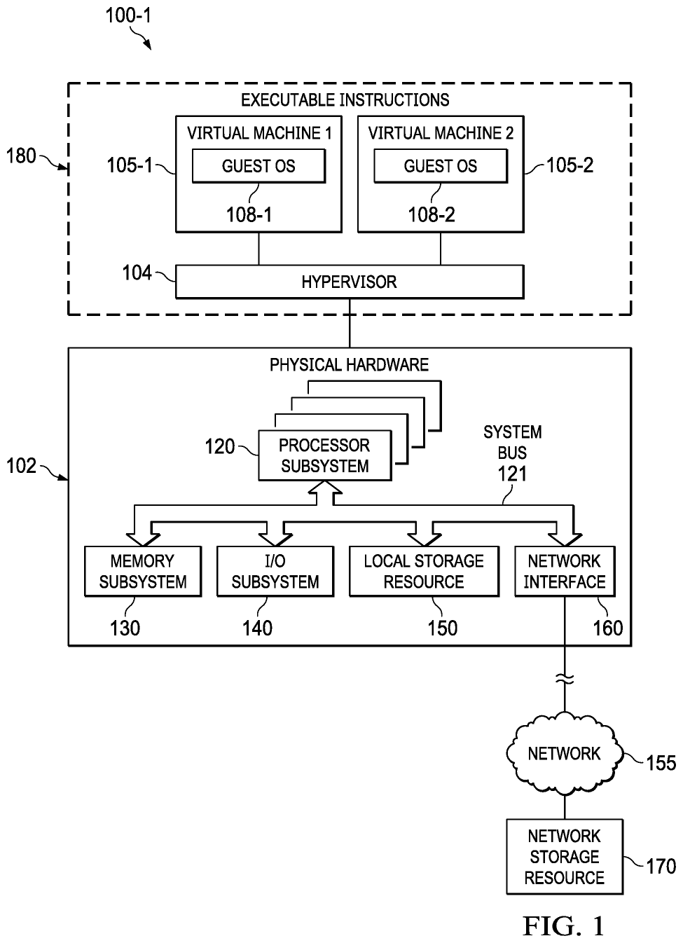

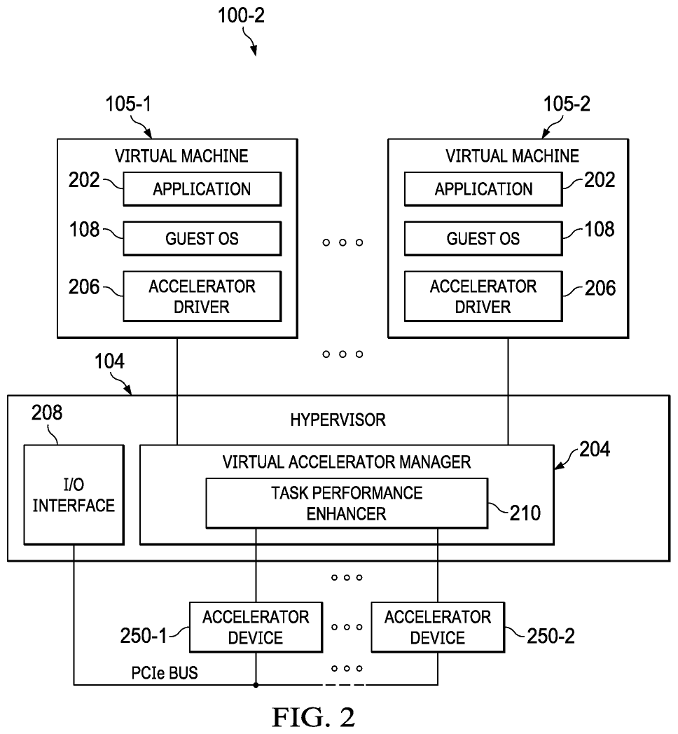

Preferred embodiments and their advantages are best understood by reference to FIGS. 1 and 2, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

For the purposes of this disclosure, circuit boards may broadly refer to printed circuit boards (PCBs), printed wiring boards (PWBs), printed wiring assemblies (PWAs) etched wiring boards, and/or any other board or similar physical structure operable to mechanically support and electrically couple electronic components (e.g., packaged integrated circuits, slot connectors, etc.). A circuit board may comprise a substrate of a plurality of conductive layers separated and supported by layers of insulating material laminated together, with conductive traces disposed on and/or in any of such conductive layers, with vias for coupling conductive traces of different layers together, and with pads for coupling electronic components (e.g., packaged integrated circuits, slot connectors, etc.) to conductive traces of the circuit board.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, device “12-1” refers to an instance of a device class, which may be referred to collectively as devices “12” and any one of which may be referred to generically as a device “12”.

Referring now to the drawings, FIG. 1 illustrates a block diagram of selected elements of an example information handling system using an I/O accelerator device, in accordance with embodiments of the present disclosure. As depicted in FIG. 1, system 100-1 may represent an information handling system comprising physical hardware 102, and executable instructions 180 (including hypervisor 104 and one or more virtual machines 105). System 100-1 may also include external or remote elements, for example, network 155 and network storage resource 170.

As shown in FIG. 1, components of physical hardware 102 may include, but are not limited to, processor subsystem 120, which may comprise one or more processors, and system bus 121 that may communicatively couple various system components to processor subsystem 120 including, for example, a memory subsystem 130, an I/O subsystem 140, local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCIe bus, HyperTransport (HT) bus, and Video Electronics Standards Association (VESA) local bus.

Network interface 160 may comprise any suitable system, apparatus, or device operable to serve as an interface between information handling system 100-1 and network 155. Network interface 160 may enable information handling system 100-1 to communicate over network 155 using a suitable transmission protocol or standard, including, but not limited to, transmission protocols or standards enumerated below with respect to the discussion of network 155. In some embodiments, network interface 160 may be communicatively coupled via network 155 to network storage resource 170. Network 155 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data or messages (generally referred to as data). Network 155 may transmit data using a desired storage or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 155 and its various components may be implemented using hardware, software, firmware, or any combination thereof.

As depicted in FIG. 1, processor subsystem 120 may comprise any suitable system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and execute program instructions or process data stored locally (e.g., in memory subsystem 130 or another component of physical hardware 102). In the same or alternative embodiments, processor subsystem 120 may interpret and execute program instructions or process data stored remotely (e.g., in network storage resource 170). In particular, processor subsystem 120 may represent a multi-processor configuration that includes at least a first processor and a second processor (see also FIG. 2).

Memory subsystem 130 may comprise any suitable system, device, or apparatus operable to retain and retrieve program instructions and data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, or a suitable selection or array of volatile or non-volatile memory that retains data after power to an associated information handling system, such as system 100-1, is powered down.

Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and data. Likewise, network storage resource 170 may comprise computer-readable media (e.g., hard disk drive, floppy disk drive, CD-ROM, or other type of rotating storage media, flash memory, EEPROM, or other type of solid state storage media) and may be generally operable to store instructions and data. In system 100-1, I/O subsystem 140 may comprise any suitable system, device, or apparatus generally operable to receive and transmit data to or from or within system 100-1. I/O subsystem 140 may represent, for example, any one or more of a variety of communication interfaces, graphics interfaces, video interfaces, user input interfaces, and peripheral interfaces. In particular, I/O subsystem 140 may include an accelerator device (see also FIG. 2) for accelerating particular processing tasks, as described in greater detail elsewhere herein.

Hypervisor 104 may comprise software (i.e., executable code or instructions) and/or firmware generally operable to allow multiple operating systems to run on a single information handling system at the same time. This operability is generally allowed via virtualization, a technique for hiding the physical characteristics of information handling system resources from the way in which other systems, applications, or end users interact with those resources. Hypervisor 104 may be one of a variety of proprietary and/or commercially available virtualization platforms, including, but not limited to, IBM's Z/VM, XEN, ORACLE VM, VMWARE's ESX SERVER, L4 MICROKERNEL, TRANGO, MICROSOFT's HYPER-V, SUN's LOGICAL DOMAINS, HITACHI's VIRTAGE, KVM, VMWARE SERVER, VMWARE WORKSTATION, VMWARE FUSION, QEMU, MICROSOFT's VIRTUAL PC and VIRTUAL SERVER, INNOTEK's VIRTUALBOX, and SWSOFT's PARALLELS WORKSTATION and PARALLELS DESKTOP. In one embodiment, hypervisor 104 may comprise a specially designed operating system (OS) with native virtualization capabilities. In another embodiment, hypervisor 104 may comprise a standard OS with an incorporated virtualization component for performing virtualization. In another embodiment, hypervisor 104 may comprise a standard OS running alongside a separate virtualization application. In embodiments represented by FIG. 1, the virtualization application of hypervisor 104 may be an application running above the OS and interacting with physical hardware 102 only through the OS.

Alternatively, the virtualization application of hypervisor 104 may, on some levels, interact indirectly with physical hardware 102 via the OS, and, on other levels, interact directly with physical hardware 102 (e.g., similar to the way the OS interacts directly with physical hardware 102, and as firmware running on physical hardware 102), also referred to as device pass-through. By using device pass-through, the virtual machine may utilize a physical device directly without the intermediate use of operating system drivers. As a further alternative, the virtualization application of hypervisor 104 may, on various levels, interact directly with physical hardware 102 (e.g., similar to the way the OS interacts directly with physical hardware 102, and as firmware running on physical hardware 102) without utilizing the OS, although still interacting with the OS to coordinate use of physical hardware 102.

As shown in FIG. 1, virtual machine 1 105-1 may represent a host for guest OS 108-1, while virtual machine 2 105-2 may represent a host for guest OS 108-2. To allow multiple operating systems to be executed on system 100-1 at the same time, hypervisor 104 may virtualize certain hardware resources of physical hardware 102 and present virtualized computer hardware representations to each of virtual machines 105. In other words, hypervisor 104 may assign to each of virtual machines 105, for example, one or more processors from processor subsystem 120, one or more regions of memory in memory subsystem 130, one or more components of I/O subsystem 140, etc. In some embodiments, the virtualized hardware representation presented to each of virtual machines 105 may comprise a mutually exclusive (i.e., disjointed or non-overlapping) set of hardware resources per virtual machine 105 (e.g., no hardware resources are shared between virtual machines 105). In other embodiments, the virtualized hardware representation may comprise an overlapping set of hardware resources per virtual machine 105 (e.g., one or more hardware resources are shared by two or more virtual machines 105).

In some embodiments, hypervisor 104 may assign hardware resources of physical hardware 102 statically, such that certain hardware resources are assigned to certain virtual machines, and this assignment does not vary over time. Additionally or alternatively, hypervisor 104 may assign hardware resources of physical hardware 102 dynamically, such that the assignment of hardware resources to virtual machines varies over time, for example, in accordance with the specific needs of the applications running on the individual virtual machines. Additionally or alternatively, hypervisor 104 may keep track of the hardware-resource-to-virtual-machine mapping, such that hypervisor 104 is able to determine the virtual machines to which a given hardware resource of physical hardware 102 has been assigned.

In FIG. 1, each of virtual machines 105 may respectively include an instance of a guest operating system (guest OS) 108, along with any applications or other software running on guest OS 108. Each guest OS 108 may represent an OS compatible with and supported by hypervisor 104, even when guest OS 108 is incompatible to a certain extent with physical hardware 102, which is virtualized by hypervisor 104. In addition, each guest OS 108 may be a separate instance of the same operating system or an instance of a different operating system. For example, in one embodiment, each guest OS 108 may comprise a LINUX OS. As another example, guest OS 108-1 may comprise a LINUX OS, guest OS 108-2 may comprise a MICROSOFT WINDOWS OS, and another guest OS on another virtual machine (not shown) may comprise a VXWORKS OS. Although system 100-1 is depicted as having two virtual machines 105-1, 105-2, it will be understood that, in particular embodiments, different numbers of virtual machines 105 may be executing on system 100-1 at any given time.

In operation of system 100-1 shown in FIG. 1, hypervisor 104 of information handling system 100-1 may virtualize the hardware resources of physical hardware 102 and present virtualized computer hardware representations to each of virtual machines 105. Each guest OS 108 of virtual machines 105 may then begin to operate and run applications and/or other software. While operating, each guest OS 108 may utilize one or more hardware resources of physical hardware 102 assigned to the respective virtual machine by hypervisor 104.

FIG. 2 illustrates a block diagram of selected elements of an example information handling system 100-2 using a plurality of accelerator devices 250 (e.g., accelerator devices 250-1 and 250-2), in accordance with embodiments of the present disclosure. In FIG. 2, system 100-2 may represent an information handling system that is an embodiment of system 100-1 (see FIG. 1). As shown, system 100-2 may include further details regarding the operation and use of accelerator devices 250, while other elements shown in system 100-1 have been omitted from FIG. 2 for descriptive clarity. In FIG. 2, for example, only two instances of virtual machines 105 and guest OSes 108 are shown, though they may represent any number of instances of virtual machines 105 and guest OSes 108.

As shown in FIG. 2, a virtual machine 105 may execute application 202 and guest OS 108. Typically, applications 202 executing on a virtual machine 105 would execute the same instructions as they would if executing on a non-virtualized operating system. The exception to such statement may occur when an application executes an instruction that requires a supervisor access, in which case virtual machine 105 may experience a virtual machine (VM) exit or other event indicating a need or desire to use an accelerator device 250. Such an event may mark a point in time in which a transition is made between an executing virtual machine (e.g., virtual machine 105) and its virtual machine manager (e.g., hypervisor 104), so that the virtual machine manager may exercise a system management function of the virtual machine to handle the event, after which the virtual machine manager may transition processor control from the virtual machine manager to the virtual machine.

To provide specialized handling of such events, hypervisor 104 may include a virtual acceleration manager 204. In operation, particular instructions executing on virtual machine 105 may trigger a VM exit or other event, thus causing hypervisor 104 to invoke virtual acceleration manager 204. For example, a particular instruction that triggers such an event may have a characteristic (e.g., particular opcode, particular payload) indicating that the instruction should be handled by an accelerator device 250; then virtual acceleration manager 204 may offload processing of the instruction (e.g., from processor subsystem 120) to an accelerator device 250.

As depicted in FIG. 2, virtual acceleration manager 204 may implement a task performance enhancer 206 configured to determine an amount of data to be transferred for each task to be executed by accelerator devices 250 and select an accelerator device 250 for each task based on the amount of data to be transferred, as described in greater detail below.

As shown in FIG. 2, each virtual machine 105 may have an accelerator driver 206 that may enable each virtual machine to access and communicate with accelerator devices 250. However, in some embodiments, accelerator driver 206 may execute within hypervisor 104 in order to enable hypervisor 104 to access and communicate with accelerator devices 250, and thus the functionality of such accelerator driver 206 executing within hypervisor 104 may be shared by the various virtual machines 105.

As shown in FIG. 2, hypervisor 104 may also implement an I/O interface 208 to which accelerator devices 250 may be communicatively coupled, for example via a PCIe bus or other suitable communications bus.

An accelerator device 250 may include any suitable hardware for accelerating processing of data and/or instructions, and may include a graphics processing unit, field programmable gate array, I/O accelerator, or any other suitable accelerator device. In operation, in response to receiving an offloaded instruction from virtual acceleration manager 204 for acceleration, an accelerator device 250 may execute the instruction and return any resultant data to virtual acceleration manager 204. Responsive to receiving an indication of the completion of the offloaded instruction from an accelerator device 250, virtual acceleration manager 204 may return the context of processing subsystem 120 from hypervisor 104 to virtual machine 105, allowing operation of application 202 issuing the hardware-accelerated instruction to continue from the point at which the VM exit or other acceleration-triggering occurred.

As mentioned above, virtual acceleration manager 204 may implement task performance enhancer 206 configured to determine an amount of data to be transferred for each task to be executed by accelerator devices 250 and select an accelerator device 250 for each task based on the amount of data to be transferred. For example, task performance enhancer 206 may calculate for each accelerator device 250 a performance index. The performance index for each accelerator device 250 may be determined based on both static factors of bandwidth for accelerator devices 250 and dynamic factors for performance of accelerator devices 250. Examples of static factors may include a memory type (e.g., GDDR2, GDDR3, GDDRS, HBM1, HBM2, etc.), memory frequency, internal bus width of an accelerator device 250, and interface speed for an accelerator device 250 (e.g., PCIe with of ×4, ×8, ×16, etc.). Dynamic factors may include available free memory of an accelerator device 250, a task memory affinity percentage for the accelerator device 250, and an available work load percentage for the accelerator device 250. For example, in some embodiments, a performance index for an accelerator device 250 may be calculated as a product of the bandwidth and the interface speed of the accelerator device 250, divided by the product of the available free memory of an accelerator device 250, the task memory affinity percentage for the accelerator device 250, and the available work load percentage for the accelerator device 250.

Further, task performance enhancer 206 may, each time it receives a task to be scheduled on an accelerator device 250, determine an amount of data transfer required from processor subsystem 120 to the selected accelerator device 250 and any amount of data transfer required from the selected accelerator device 250 to processor subsystem 120 in connection with the task. Based on the amount of data to be transferred, task performance enhancer 206 may select an accelerator device 250 to execute the task, and distribute the task to such selected accelerator device 250. For example, task performance enhancer 206 may select accelerator devices 250 with higher bandwidth and/or higher performance index for higher amounts of required data transfer, and may select accelerator devices 250 with lower bandwidth for lower amounts of required data transfer.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. An information handling system, comprising:
a plurality of hardware accelerator devices; and
a processor subsystem having access to a memory subsystem and having access to the plurality of hardware accelerator devices, wherein the memory subsystem stores instructions executable by the processor subsystem, the instructions, when executed by the processor subsystem, causing the processor subsystem to:
responsive to issuance of, by an application executing on a virtual machine of a hypervisor executing on the processor subsystem, an instruction triggering an event for use of a selected hardware accelerator device of the plurality of hardware accelerator devices, invoke a virtual acceleration manager of the hypervisor to handle the instruction;
determine by the virtual acceleration manager an amount of data to be transferred between the processor subsystem and the selected hardware accelerator device;
select by the virtual acceleration manager the selected hardware accelerator based on the amount of data to be transferred; and
distribute by the virtual acceleration manager the instruction to the selected hardware accelerator device.

2. The information handling system of claim 1, wherein the instructions are further for causing the processor subsystem to select by the virtual acceleration manager the selected hardware accelerator based on individual interface speeds associated with each of the plurality of hardware accelerator devices.

3. The information handling system of claim 2, wherein the individual interface speeds are interface speeds associated with Peripheral Component Interconnect Enhanced interfaces coupled to the plurality of hardware accelerator devices.

4. The information handling system of claim 1, wherein the instructions are further for causing the processor subsystem to select by the virtual acceleration manager the selected hardware accelerator based on individual communication bandwidths associated with each of the plurality of hardware accelerator devices.

5. The information handling system of claim 1, wherein the instructions are further for causing the processor subsystem to select by the virtual acceleration manager the selected hardware accelerator based on individual performance indexes associated with each of the plurality of hardware accelerator devices.

6. The information handling system of claim 5, wherein each individual performance index is based on one or more of a memory type, a memory frequency, an internal bus width, interface speed, an available free memory, a task memory affinity percentage, and an available work load percentage of a hardware accelerator device associated with the individual performance index.

7. The information handling system of claim 1, wherein the plurality of hardware accelerator devices comprises a plurality of graphics processing units.

8. A method comprising:
responsive to issuance of, by an application executing on a virtual machine of a hypervisor executing on a processor subsystem, an instruction triggering an event for use of a selected hardware accelerator device of a plurality of hardware accelerator devices, invoking a virtual acceleration manager of the hypervisor to handle the instruction;
determining by the virtual acceleration manager an amount of data to be transferred between the processor subsystem and the selected hardware accelerator device;
selecting by the virtual acceleration manager the selected hardware accelerator based on the amount of data to be transferred; and
distributing by the virtual acceleration manager the instruction to the selected hardware accelerator device.

9. The method of claim 8, further comprising selecting by the virtual acceleration manager the selected hardware accelerator based on individual interface speeds associated with each of the plurality of hardware accelerator devices.

10. The method of claim 9, wherein the individual interface speeds are interface speeds associated with Peripheral Component Interconnect Enhanced interfaces coupled to the plurality of hardware accelerator devices.

11. The method of claim 8, further comprising selecting by the virtual acceleration manager the selected hardware accelerator based on individual communication bandwidths associated with each of the plurality of hardware accelerator devices.

12. The method of claim 8, further comprising selecting by the virtual acceleration manager the selected hardware accelerator based on individual performance indexes associated with each of the plurality of hardware accelerator devices.

13. The method of claim 12, wherein each individual performance index is based on one or more of a memory type, a memory frequency, an internal bus width, interface speed, an available free memory, a task memory affinity percentage, and an available work load percentage of a hardware accelerator device associated with the individual performance index.

14. The method of claim 8, wherein the plurality of hardware accelerator devices comprises a plurality of graphics processing units.

15. An article of manufacture comprising:
a non-transitory computer-readable medium; and
computer-executable instructions carried on the computer-readable medium, the instructions readable by a processor, the instructions, when read and executed, for causing the processor to:
responsive to issuance of, by an application executing on a virtual machine of a hypervisor executing on a processor subsystem, an instruction triggering an event for use of a selected hardware accelerator device of a plurality of hardware accelerator devices, invoke a virtual acceleration manager of the hypervisor to handle the instruction;
determine by the virtual acceleration manager an amount of data to be transferred between the processor subsystem and the selected hardware accelerator device;
select by the virtual acceleration manager the selected hardware accelerator based on the amount of data to be transferred; and
distribute by the virtual acceleration manager the instruction to the selected hardware accelerator device.

16. The article of claim 15, wherein the instructions are further for causing the processor to select by the virtual acceleration manager the selected hardware accelerator based on individual interface speeds associated with each of the plurality of hardware accelerator devices.

17. The article of claim 16, wherein the individual interface speeds are interface speeds associated with Peripheral Component Interconnect Enhanced interfaces coupled to the plurality of hardware accelerator devices.

18. The article of claim 15, wherein the instructions are further for causing the processor to select by the virtual acceleration manager the selected hardware accelerator based on individual communication bandwidths associated with each of the plurality of hardware accelerator devices.

19. The article of claim 15, wherein the instructions are further for causing the processor to select by the virtual acceleration manager the selected hardware accelerator based on individual performance indexes associated with each of the plurality of hardware accelerator devices.

20. The article of claim 19, wherein each individual performance index is based on one or more of a memory type, a memory frequency, an internal bus width, interface speed, an available free memory, a task memory affinity percentage, and an available work load percentage of a hardware accelerator device associated with the individual performance index.

21. The article of claim 15, wherein the plurality of hardware accelerator devices comprises a plurality of graphics processing units.
